(19) United States
(12) Patent Application Publication
(10) Pub. No.: US 2015/0338982 A1
(43) Pub. Date: Nov. 26, 2015

(54) SYSTEM, DEVICE AND METHOD FOR EMULATING USER INTERACTION WITH A TOUCH SCREEN DEVICE

(71) Applicant: CRUNCHY LOGISTICS LLC, Orlando, FL (US)

(72) Inventors: Neil DUFVA, Orlando, FL (US); Mario FELIZOLA, Miami, FL (US); Aaron BITLER, Orlando, FL (US); Jonathan COPELAND, Lakeland, FL (US); Stephen COPELAND, Lakeland, FL (US)

(73) Assignee: CRUNCHY LOGISTICS LLC, Orlando, FL (US)

(21) Appl. No.: 14/282,574

(22) Filed: May 20, 2014

(51) Int. Cl. G06F 3/041; G06F 3/023; G06F 3/02

(52) U.S. Cl. CPC G06F 3/0416; G06F 3/0412; G06F 3/0227; G06F 3/023

(57) ABSTRACT

An apparatus for emulating user interaction with a touch screen device, including an actuator array having rows and columns of actuator pads, the actuator pads being arranged to interact with a tactile surface of the touch screen of the touch screen device, each actuator pad being configured to generate a touch event on the tactile surface of the touch screen device, an actuator array driver including driving units for each actuator pad, each driving unit configured to receive a control signal for generating the touch event by starting and stopping the touch event of the corresponding actuator pad, and an actuator array controller connected to the actuator array driver, the actuator array controller configured to generate the control signal for the driver.

### FIELD OF THE INVENTION

The present invention relates to touch actuator system, device, and method for emulating user interaction with a touch screen of an electronic device that can be used for automated, programmed, or remote manipulation of the electronic device.

### BRIEF DESCRIPTION OF THE RELATED ART

The continued growth and popularity of portable terminals for mobile communication, for example smartphones, hand-held electronic devices, touchpads, portable personal computers, as well as the increased commercialization of multimedia services accessed using portable terminals has seen a commensurate increase in the demand for various display devices and the input devices for inputting data therethrough. To meet such growing demands, and the demands for rendering the portable terminals more compact and lightweight, touch screens are increasingly used to operate concurrently both as an input device and a display device.

Generally touch screens may be classified into resistive touch screens and capacitive touch screens. The resistive touch screen generates an input signal by sensing a position on the touch screen at which a user applies a touching force or pressure causing contact between two resistive screen layers, for example with his own finger, finger nail, or by using a device, such as a touch pen, pencil, finger of a glove. The capacitive touch screen generates an input signal by sensing a position on the touch screen at which a user applies a touch causing a change in detected capacitance from a micro-current flowing through a user's body, i.e., the user's finger. The capacitive touch screen, when compared to the resistive touch screen, usually provides a smoother feeling of manipulation and action, for example the scrolling of graphical elements. Thus, the user may feel that a portable terminal using a capacitive touch screen is more elegant than a portable terminal using a resistive touch screen, and in the field of portable terminals, the capacitive touch screen is more commonly used. On the other hand, since the capacitive touch screen operates by a human's micro-current, it cannot be manipulated using a general tool such as a pen or a pencil, or even a conventional gloved finger.

Because of growing security demand in the mobile terminal and device marketplace, device operating systems and software are becoming more and more locked down for less customization and reduced potential threat of hacking and viruses. This makes remote management and manipulation of mobile devices very difficult for information technology departments of large and small organizations. Therefore, a strong need exists to provide for a device that can interact with touch screens.

### SUMMARY

According to one aspect of the present invention, an apparatus for emulating user interaction with a touch screen device is provided. The apparatus preferably includes an actuator array having rows and columns of actuator pads, the actuator pads being arranged to interact with a tactile surface of the touch screen of the touch screen device, each actuator pad being configured to generate a touch event on the tactile surface of the touch screen device, and an actuator array driver including driving units for each actuator pad, each driving unit configured to receive a control signal for generating the touch event by starting and stopping the touch event of the corresponding actuator pad. Moreover, the apparatus further preferably includes an actuator array controller connected to the actuator array driver, the actuator array controller configured to generate the control signal for the driver.

According to another aspect of the present invention, a method of controlling a touch screen device is provided. The method preferably includes the steps of attaching the touch screen device to an actuator array that is configured to generate touch events for a touch screen of the touch screen device, the actuator array covering the touch screen such that the actuator array can operate the touch screen, and receiving touch control signals from a remote device over the network at a control device, the control device operatively connected to the actuator array. Moreover, the method further includes the step of generating touch events for the touch screen by the actuator array, based on the received touch signals.

The summary of the invention is neither intended nor should be construed as being representative of the full extent and scope of the present invention, which additional aspects will become more readily apparent from the detailed description, particularly when taken together with the appended drawings.

### BRIEF DESCRIPTION OF THE SEVERAL VIEWS OF THE DRAWINGS

FIG. 1 shows a perspective view of an exemplary system using a device for emulating user interaction with a touch screen, according to an embodiment;

FIG. 2 shows a perspective view of the device for emulating user interaction coupled with a device having a touch screen according to an embodiment;

FIG. 3 shows a cross-sectional view of the device for emulating user interaction coupled with the device having a touch screen, according to an embodiment;

FIG. 4 shows a schematic view of a circuit and driver of the device for emulating user interaction according to another embodiment;

FIG. 5 shows a schematic view of different touch patterns that can be generated by the device for emulating user interaction, according to still another embodiment;

FIG. 6 shows a schematic view of dual contact point touch patterns that can be generated by the device for emulating user interaction, according to yet another embodiment;

FIG. 7 shows a schematic view of a circuit and driver of the device for emulating user interaction according to an additional embodiment;

FIG. 8 shows a perspective view of another system for using the device for emulating user interaction with a touch screen, according to another embodiment; and

FIG. 9 shows a perspective schematic view of a system for using the device for emulating user interaction with a touch screen for automotive electronics, according to still another embodiment.

Herein, identical reference numerals are used, where possible, to designate identical elements that are common to the figures. The images in the drawings are simplified for illustrative purposes, and are not necessarily depicted to scale.

### DETAILED DESCRIPTION OF THE EMBODIMENTS

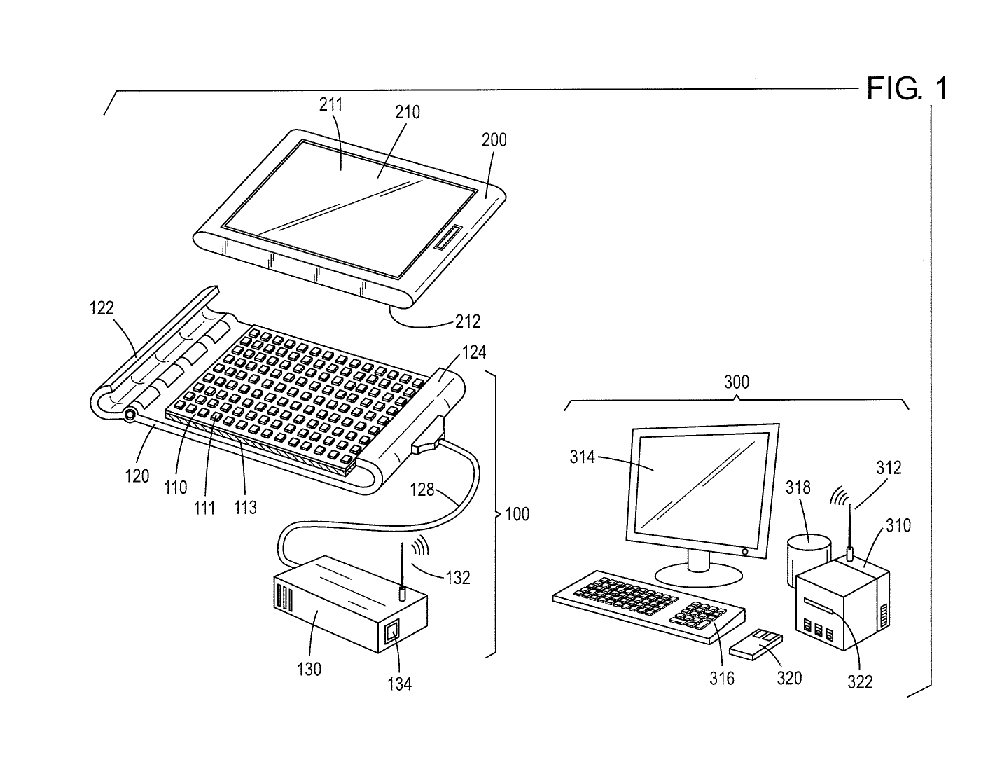

FIG. 1 depicts a touch actuator system 100, an electronic device 200 having a touch screen 210 that has a tactile surface 211, and a data processing device 300, for example, but not limited to, a personal computer, server, digital processing equipment. The touch actuator system 100 has a touch actuator 120 that has an actuator array 110 of actuator pads 111 which can be individually controlled to emulate a movement or a signal that is capable of simulating the effect incurred when a person's finger or another body part, or a pointing device capable of operating a touch screen 210 comes into contact with the touchscreen 210 of the electronic device 200, such as a smart phone, personal digital assistant (PDA), tablet computer, cell phone, portable handheld electronic devices such as but not limited to global positioning system mapping devices, chart plotters, car computers, audiovisual playback devices. The touch actuator system also includes a controller device 130 that allows to control the individual actuator pads 111 of the actuator array 110. In the embodiment shown, touch actuator 120 and controller device 130 are two separate devices that are connected to each other via a communication cable 128, however it would be readily appreciated that the controller device 130 could instead be an integral or removable part of the touch actuator 120 itself.

In the embodiment shown in FIG. 1, the touch actuator has a matrix of actuator pads 111 arranged in nine (9) rows by fourteen (14) columns, resulting in a total of one-hundred and twenty-six (126) individual controllable actuator pads 111. However, other arrangements and quantities of pads 11 may be used as desired. The upper surface of each actuator pad 111 is depicted as having a square shape, however, it should be readily apparent that other pad shapes are possible. For example, actuator pads 111 having a non-square shape, such as, but not limited to, rectangular, round, oval, parallelepiped shapes may be used. Also, the pads 111 could be located in triangularly arranged groupings. Furthermore, the number of actuator pads 111 for touch actuator 120 may vary and depends on the electronic device 200 that is to be controlled. Preferably, the number of actuator pads 111 per surface area depends on the actual resolution of the tactile surface 211 of the touch screen 210, and may be chosen to have about five (5) to eight (8) actuator pads per square inch. As an example, for a touch screen having the size of 4.5″ to 2.5″ such as the Samsung Galaxy S4 touch screen, usually the actuator array 120 would consist of a matrix of a minimum of twelve (12) rows by seven (7) columns of actuator pads 111, but could be operated by a touch actuator 120 having an array with a higher count of pads 111. Also, the spacing between respective neighboring pads 111 is shown even and relatively narrow, so that a continuous touch swipe or movement over a surface of touch screen 210 can be emulated. Typically, a distance between edges of neighboring actuator pads 111 is very small, in the range of 0.1 mm to 0.4 mm, however even closer spacing is possible so long as actuation of one pad does not cause an unintended actuation of an adjacent pad.

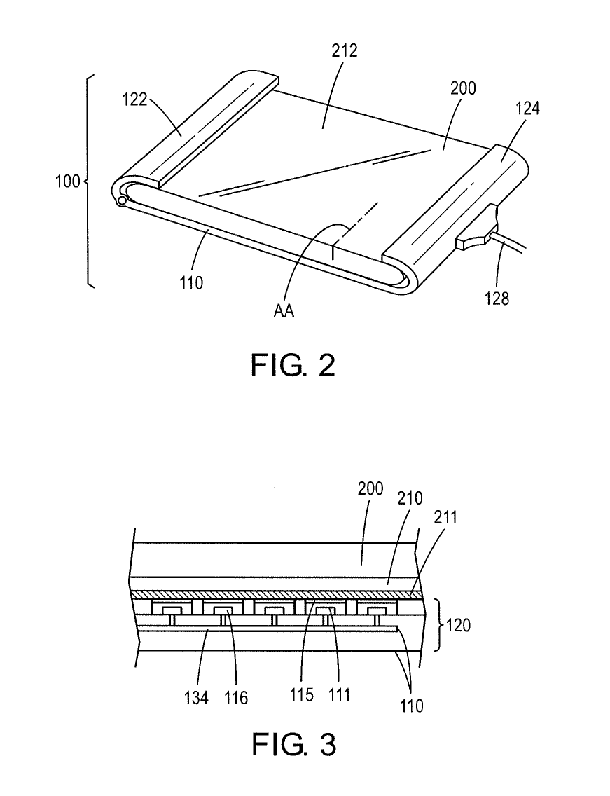

For controlling the electronic device, touch actuator 120 is brought into contact with the electronic device 200 such that the upper surface of pads 111 of the actuator array 110 come into contact with tactile surface 211 of the touch screen 210. Given the example shown in FIG. 1, electronic device 200 is flipped over such that tactile surface 211 of touch screen 210 faces the actuator array 110. One end of the device 200 is slid into a holder arm 124, and a clip arm 122 is then flipped over and snapped onto the other end of the electronic device 200 so that holder arm 124 and clip arm 124 engage the rear surface 212 of device 200 so as to cause the pads 111 of actuator array 110 to be in contact with the tactile surface 211 of touch screen 210, as shown in FIG. 2, which depicts a perspective view of the electronic device 200 engaged with the touch actuator system 100. The individual actuator pads 111 of the actuator array 110 are arranged to form a matrix of touch points such that an operation of the entire surface of the touch screen 210 can be emulated.

Each actuator pad 111 of actuator array 110 includes a driving unit 116 and pad 11 and driving unit 116 are designed so that a touch control signal S can be applied and removed to the respective pad 111 with a fast response rate, including a fast signal application time and a fast signal removal time. Typically, operation frequency for touch control signal S can be at about 100 kHz. The maximal frequency of the touch control signals S is preferably designed such that it is faster or the same as the scanning frequency of the touch screen 210 that is to be controlled, and therefore driving unit 116 and actuator pad 111 are designed depending on the technology used for the touch screen 210, including the scanning frequency. Touch actuator system 100 further includes a control unit 130 that is connected to touch actuator 120 via a connection 128 that generates signals to control touch actuator 120, for example touch control signals S, or other signals that can control the touch actuator 120. Control unit 130 itself can be connected to a data processing device 300, for example but not limited to a network connection such as an Ethernet port 134, wireless connection 132, universal serial bus connection (USB), serial data connection, or Bluetooth™ connection, high-definition multimedia interface (HDMI) connection. Data processing device 300 that can act as a supervisory control system of control unit 130.

An exemplary embodiment of data processing device 300 is shown in FIG. 1 and can include a display screen 314, data input device 316 such as a keyboard, processing unit 310 having access to a network with a wireless or wired connection 312, and also having access to control unit 130 of the touch actuator system 100. Processing unit 310 can further be connected to a storage device 318 for storing and archiving data, and can also be equipped with a removable storage device reader and writer 322 that allows to read, write, and erase data to a non-transitory removable data storage device 320. Data processing device 300 can send master control signals MCS to control unit 130 of touch actuator system 100, for example coordinate information on a desired emulated touch position, or a series of coordinates with a desired trajectory of a desired emulated touch swipe or movement, and control unit 130 can generate the requisite touch control signals S for actuator array 110 to emulate the touch event at the desired touch position. In FIG. 1, processing unit 310, control unit 130 are shown as separate components that are in communication with each other. However, it is also possible that control unit 130 and processing unit 310 may be integrated into the same device, and may even include control unit 130, processing unit 310, and touch actuator 120 integrated into the same device.

FIG. 3 shows a portion of a cross sectional view through electronic device 200 and touch actuator 120 that are engaged with each other, along the line A-A shown in FIG. 2. As shown, touch actuator 120 includes a plurality of actuator pads 111 arranged in a row that each have a conductive contact surface 115 that is in direct contact with tactile surface 211 of touch screen 210. When capacitive touch technology is used for the tactile surface 211 of touch screen 210, actuator array 110 is designed to emulate or simulate a touch or contact of a user's body, such as his/her finger or capacitive stylus. Under normal conditions, the dielectric constant of the body of a user disrupts the electric field of the touch screen 210, which results in a change of measured capacitance across the sensing lines of touch screen 210. Actuator pads 111 of grid array 110 are made such that each pad 111 is designed to able to apply an electric signal V to tactile surface 211 of touch screen 210. That is achieved by forming pad 111 with an electrically conductive surface on the contact surface 115. As discussed above, each actuator pad 111 is equipped with a driver unit 116 that can apply the electric signal V to the conductive contact surface 115 to create a touch event, and because conductive contact surface 115 is in contact with tactile surface 211 of touch screen 210, this signal will be detectable by touch screen upon a readout scan thereby detecting the touch point. Because the human body is also an electrical conductor, touching the surface of the screen results in a distortion of the touch screen's electrostatic field, measurable as a change in capacitance, which is about 100 pF. The application of the electric signal V to the tactile surface 211 via the conductive contact surface emulates this change in capacitance, so that a touch signal is detected by device 200 upon application of signal V.

The electric signal V that is applied to contact surface and tactile surface 211 varies depending on the touch screen 210 and device 200 used. For example, for the Apple Ipad® device, the ground signal of the device was used as the applied electric signal V. In other instances, a floating ground signal can be applied, or a certain voltage level. Each driver unit 116 is connected via signal lines 139 to a signal buffer 131 that can buffer the control signals S. The contact between the tactile surface 211 of touch screen 210 and conductive contact surface 115 of the pad is configured to apply a certain pressure onto screen 210 in order to prevent erroneous touch signals and to allow for emulated touch signals to be properly registered by device 200. Moreover, conductive contact surface 115 is configured to be flexible and bendable to account for geometric variations that occur in the tactile surface 211 of the touch screen 210, due to the variations in the manufacturing process or ambient and device temperature variations.

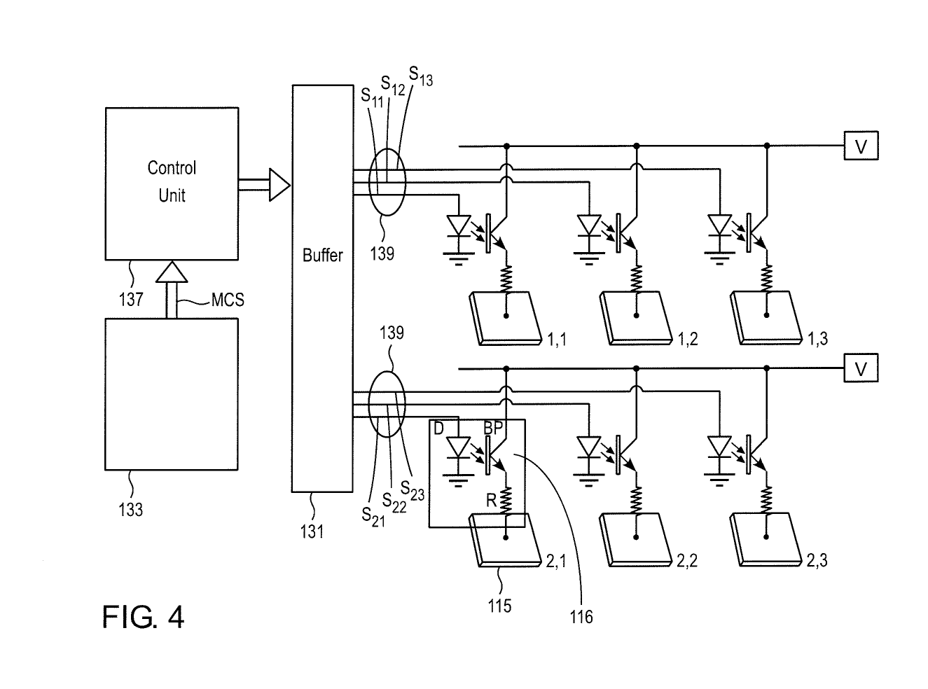

FIG. 4 shows a schematic view of an exemplary control circuit for touch actuator system 100, when the touch sensing technology of the touch screen 210 is capacitive. An exemplary two (2) by three (3) matrix I shown with a total of six (6) conductive contact surfaces 115 of the actuator pads 111. However, the present invention is not limited to such configuration, and many more pads 111 may be present, for both the rows and the columns. Each actuator pad 111 includes a driver unit 116 that receives a corresponding touch control signals S, and shown in FIG. 4, the touch control signals S are indexed based on row and column position. Driver unit 116 includes an opto-coupler that allows to galvanically separate touch control signals S and the circuit that applies an electric signal V to the conductive contact surface 115. For example, touch control signal S exits buffer 131 and is applied to driver unit 116 via a light emitting diode D of the opto-coupler, to turn on a bipolar transistor BP of the opto-coupler that will apply the electric signal to conductive contact surface 115 via a resistor R. The plurality of touch control signals S that connect buffer 131 with driver units 116 are arranged in signal lines 139. In the embodiment shown, a resistance R of 1 kΩ is used with the dimensions of contact surface being 115 of 9.7 mm×9.7 mm, and with buffer 131 being a general purpose parallel input/output expander.

Buffer 131 is usually arranged to be a part of the touch actuator 120, and can be split into individual buffers for different rows and columns. Buffer 131 itself receives the control signals from a control unit 137 that can be a signal processor or a logic array implemented as a Field Programmable Gate Array (FPGA), Complex Programmable Logic Device (CPLD), microprocessor, microcontroller, Application Specific Integrated Circuit (ASIC), that can convert coordinate information for a desired touch position on the touch screen 210 into a set of touch control signals S for generating the touch event. For example, control unit 137 can receive a master control signal MCS from an external device 133 in the form of a positional x-y coordinate for a desired touch position PP. The desired touch position can correspond to a place where an icon is presented on the graphical user interface that is displayed by touch screen 210 of the electronic device 200, for example an application icon. Next, the control unit 137 converts the MCS into a touch event, by generating a set of touch control signals S that are applied to a set of actuator pads 111 via corresponding driving units 116. The external device 133 can be another signal processor or logic array, and may be part of control unit 130, and can include a communication interface to communicate with data processing device 300.

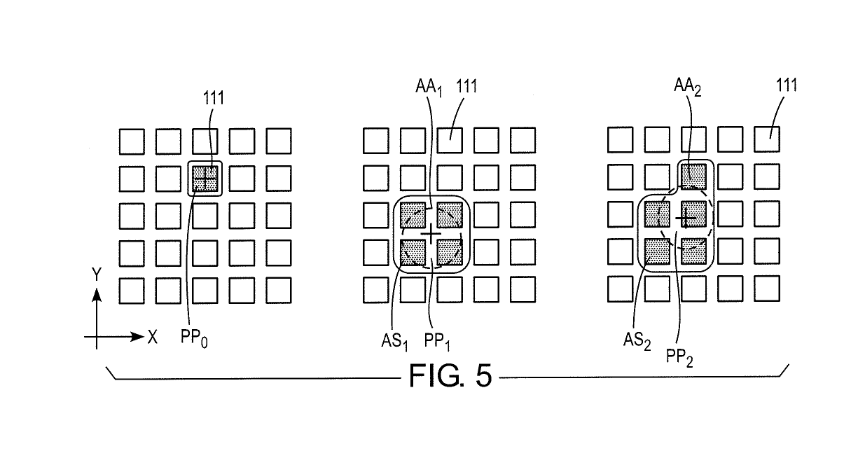

Referring now to the example in FIG. 5, a touch event can be generated by activating the actuator pad 111 via the corresponding driving unit 116 with the touch control signal that corresponds to a coordinate location of the desired touch position PP₀ on the tactile surface 211 of touch screen 210. Alternatively, it is also possible to activate a set AS of actuator pads 111 via corresponding driving units 116 to generate a touch event. For example, in a case where the desired touch position PP₁, PP₂ is not located within the surface area that is covered by a single actuator pad 111, it is possible to activate all the actuator pads 111 that are in a certain predetermined proximity of desired touch position PP₁, PP₂ to activate a set AS₁, AS₂ of actuator pads 111, for example a defined activation area AA₁, AA₂. In the embodiment shown in FIG. 5, the activation area AA₁, AA₂ is an area within a radius R of the desired touch position PP₁. However, different activation areas can be defined, for example a square-shaped area, etc. The resulting position of the touch event on the tactile surface 211 of touch screen 210 will thereby be approximated by a centroid or geometric center of the surface area covered by the set AS₁, AS₂ of actuator pads 111, depending on the way the electronic device 200 calculates the effective touch position.

An algorithm that can be implemented in control unit 137 can convert the MCS into a touch event by generating a set of touch control signals S that are applied via signal lines 139 to actuator pads 111. For example, in a case where the MCS is a desired touch position PP, the control unit 137 can first store the MCS signal in a memory. Next, an activation area AA around the desired touch position PP is calculated, for example a circular area that has a defined radius R from the desired touch position PP, or a square area that corresponds to a certain grid size of the actuator array 110. Other sizes and shapes of the activation areas AA are also possible, centered or approximated around the touch position PP. Next, the set AS of actuator pads 111 is determined. In this step, actuator pads 111 that are located either partially or fully within the activation area AA are selected as being the actuator pads 111 that will generate the touch event. Next, the control unit 137 generates a set of touch control signals S for the set AS of actuator pads 111 that have been determined, and these touch control signals S are provided to buffer 131. These steps of the method to determine a set of touch control signals S based on the MCS can be done in real time within a defined sampling period, to be synchronous with changes of the MCS signal, or with asynchronously with a short latency time.

Alternatively, it is also possible that the MCS signal does not simply consist in a desired touch position PP, but in a series of desired touch positions that are associated with different time instances, for example, and entire touch movement or touch swipe on the tactile surface 211 of screen 210. In such instances, a data set having a plurality of desired touch positions PP associated with respective time instances is transferred from external device 133 to control unit 137, and is stored at control unit 137. Next, for each desired touch position PP, a corresponding set of touch control signals S is generated with a timing that is synchronized to the transferred time instances for the respective desired touch positions PP to generate consecutive touch events that emulate a touch movement or touch swipe on the touch screen 210.

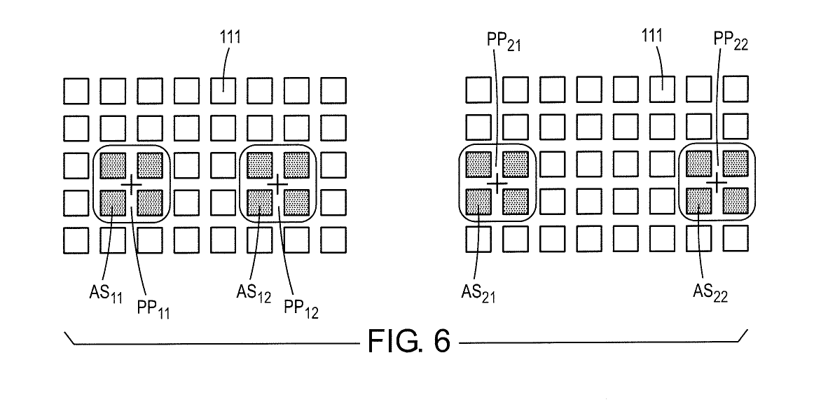

In FIG. 6 shows an embodiment in which two different desired touch positions PP are generated as touch events simultaneously, or in close succession. This variant may be used if a two-finger operation of a touch screen 210 has to be emulated, for example the zooming operation by a user spreading two fingers on a touch screen. In this variant, the MCS signal can have coordinates of two different desired touch positions PP₁₁ and PP₁₂, including a flag or a signal that indicates that these two touch positions have to be generated simultaneously. Corresponding activation areas AA are defined and two corresponding sets AS₁₁ and AS₁₂ of actuator pads 111 are generated, each corresponding to the two desired touch positions PP₁₁ and PP₁₂. Next, a set of touch control signals S are generated and applied to signal lines 139. In the embodiment shown, the subsequent desired touch positions PP₂₁ and PP₂₂ are extending in distance from each other, and two corresponding sets AS₁₁ and AS₁₂ of actuator pads 111 for the next, subsequent touch event are different from the previous touch event.

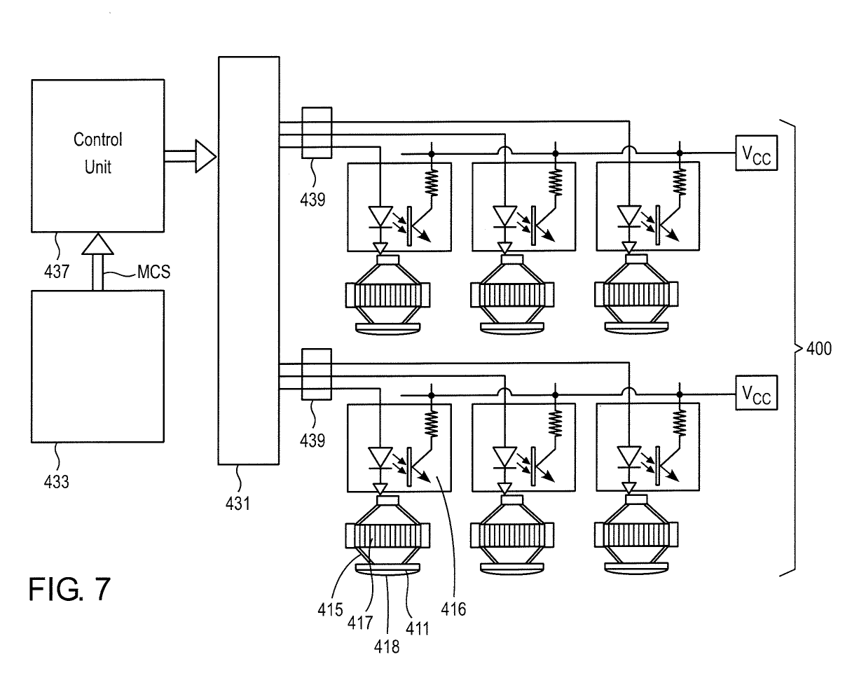

FIG. 7 depicts a schematic view of an exemplary control circuit for touch actuator system 100, when the touch sensing technology of the touch screen 210 is resistive or uses another technology that is pressure or force sensitive. Instead of having actuator pads 111 and conductive contact surfaces 115, micro-actuators 415 are used that can generate a force onto the tactile surface 211 of the force-sensing touch screen 210. Micro-actuators 415 are also arranged in an array along rows and columns, and can be implemented as amplified piezoelectric actuators with one or more piezo elements 417 that can be activated by an electric signal to generate a touch event. Actuator pads 411 include a spherical surface 418 that is configured to be in contact or in close proximity of tactile surface 211 of touch screen 210. Corresponding driver units 416 are arranged for reach micro-actuator 415, and allow for a galvanic separation of touch control signals S and a signal that activates the micro-actuators 415. Spherical surface 418 of actuator pads 411 allows for a reduced application of force to generate a touch event, without damaging the tactile surface 211. A power signal VCC is fed to each driver unit 416 to provide activation energy for each micro-actuator. The micro-actuators 415 form an actuator array 410 that can be implemented with micro- or nano-mechanical technology on the same substrate. Buffer 431 provides for the touch control signals S via signal lines 439.

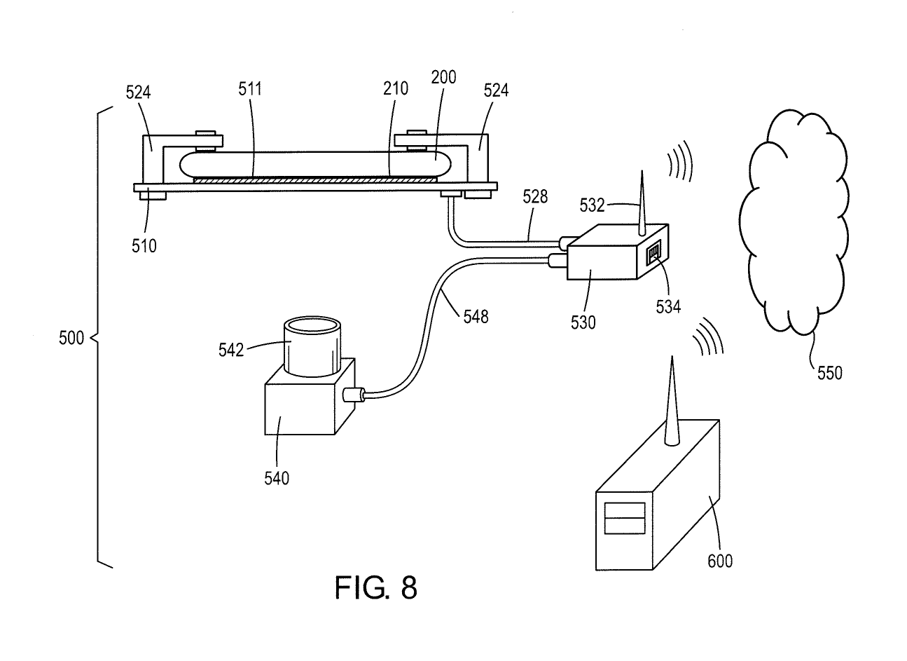

FIG. 8 schematically depicts a touch actuator system or device 500 in which a transparent actuator array 510 with transparent actuator pads 511 is attached to a corresponding electronic device 200 by means of clamping device 524. This arrangement allows control of a graphical user interface of the electronic device 200 that is displayed on touch screen 210, and at the same time, use a camera 540 or a human operator to observe the activity of the touch screen 210. In this embodiment, the area of actuator array 510 is made of material that is transparent to the visual light range, using conducting transparent material and insulating transparent material, so that the contents of touch screen 210 can be viewed without any obstruction, even while operating the touch screen 210 of electronic device 200. In the case where the driver units are arranged in the actuator array 510, the opto-couplers can be operated with light outside of the visual light range, so that the light of the opto-couplers does not interfere with the light of the touch screen 210. Actuator array 510 is connected with a cable 528 to a control device 530, and can receive touch control signals S or MCS from control device for controlling the touch events in manners similar to those described above.

In the embodiment shown, a camera 540 is arranged such that its optical axis intersects with the arrangement of electronic device 200 and actuator array 510, facing the touch screen 210. Camera 540 is equipped with a lens 542 that is configured such that the field of view allows to capture the entire screen content of the touch screen 510 by camera 540. Camera 540 can digitize the image data and send it via connection 548 to control device 530. For example, camera 540 can operate in video mode and constantly transfer a stream of images of the touch screen 210 to control device 530. Control device 530 itself can be connected with the Internet or another network 550 with network interface 534 or wireless interface 532. A maintenance server 600 is connected via the Internet or another network 550 to control device 530. The actuator array 510 makes it possible to simulate all human interaction with the device 200 with touch screen 210 remotely for complete remote manageability, and can also include the pressing of hard physical buttons of device 200 through miniature linear actuators. With this arrangement, a plurality of actuator systems 500 can be connected via the Internet to a remotely located maintenance server 600, and an operator or an automated process can remotely access a plurality of electronic devices 200, for example for remote maintenance purposes.

As described above, system 500 can be used for remote support of electronic devices 200 having touch screen 210. Whenever remotely managed support is required for a device 200, it is possible that different settings and configurations will have to be verified locally on device 200 via touch screen, that will require access to certain privileged, authenticated, or secured portions of the device 200, for example after a software or operating system update to device 200. Without being able to operate the touch screen 210 of device 200, it may be very difficult for the remote support system or operator to resolve certain issues, simply because one may not be able to rely on their management software of device 200 to perform maintenance on device 200 having a touch screen 210 for a successful update. By using system 500, it is possible to avoid this problem by directly interfacing and operating device 200 remotely through the same graphical user interface that is presented to the user by the remote support system.

Another method and system for using the touch actuator device 100, 500 can be in conjunction with home or other entertainment systems that are configured integrate electronic device 200 with touch screen 210, such as tablets and smartphones, for example with television sets, set-top boxes, computer systems, audio equipment to provide users with a reproduction of the graphical user interface of device 200 on the much larger television screen, to generate an interface of device 200 that is operable via the television set. For this purpose, the television itself can be equipped with a touch sensitive screen, or has another device that is able to capture a touch position on the television screen by the user, for example by stereo camera system. Conventionally, entertainment systems that allow the integration of a smartphone or tablet rely on software screen operation signals via Bluetooth, USB port, or other customary data part to emulate the touching of the touch screen 210 with touch points and swipes that are captured from the user that is operating the television. However, such operation of electronic device 200 by software requires special applications that are installed on device 200, and may even require partial reconstruction or a complete redesign of the operating system of device 200 for programming such interface. Such additional software in device 200 may require frequent updates, and also additional computer processing overhead for device 200. Instead, touch actuator device 100, 500 can be used and connected to the entertainment system, or an be an integral part of entertainment system, so that a user can insert their device 200, such a tablet or a smartphone, into actuation device 100, 500 for interconnection with entertainment system, and, thus, device 100, 500 is used instead of software screen operation signals, providing several advantages over the conventional art.

Moreover, the touch actuator device 100, 500 can also be used during manufacturing processes for touch screens 210 for testing different types of touch screens, such as capacitive and resistive touch screens. For example, during the manufacturing process of touch screen 210, it may necessary to test the reliability for each touch sensing point. The touch actuator device 100, 500 could be used to speed up this process to meet the needs for production quality by manufacturers, by providing a fast and reliable testing system. For example, touch actuator device 100, 500 could be part of a system that presses down the actuator array 110 onto a manufactured touch screen 210, and thereafter performs a variety of touch emulation tests, for example by testing all available touch sensing points, but also by generating a large number of more complex touch patterns and touch swipes, at different speeds. The results of this testing can be reviewed by an operator or a controlling device that can verify if the touch screen 210 under test complies with certain performance benchmarks based on a test specification, for example by use of transparent actuator array 510 and camera 540 to decide whether touch screen 210 is ready for sale on the market or integration into a device 200.

Moreover, the touch actuator device 100, 500 can also be used in automotive, marine, and other mobile electronic applications, to integrate device 200 having a touch screen 210 into the existing electronics systems. As an example, in many vehicles today, display screens are provided that are touch sensitive and can be actuated by a finger, pointing device, or stylus by a user or driver, to operate the integrated car electronics. Such display screens can be integrated into the dashboard, for example the middle console, or be part of a head up display having stereo cameras or other touch detecting system for display and interaction with user or driver. Automotive electronic system are configured to perform various functions such as but not limited to the providing mapping based on the global positioning system (GPS), play music from music files, play music videos, receive mobile data for music and video streaming, receive satellite data for radio and other purposes, receive and display traffic data, control various engine settings and drive control settings, show historic data on distance, gas consumption, temperature etc. However, many users already frequently use their smartphone or tablet computer for many of these functions, and often do not want to use the automotive electronic system to perform these functions. Also, some smartphones and tables are often configurable with an application to remotely control other electronic devices that may be part of the automotive electronic system. In addition, users or drivers are often more familiarized with using the interface presented by their smart phone or tablet as compared to the use of the automotive electronic system, have often a large quantity of content data stored on the smartphone or tablet, and usually provide for a mobile or cell phone data connection that is often lacking in cars, boats, vehicles, and other mobile equipment. Therefore, another aspect of the present invention is a method and corresponding system that allows to integrate the device 200, such as a smartphone or tablet, into the existing automotive, marine, or other mobile electronics, and to use the touch sensitive display 655 of the built-in automotive electronic system to operate the smartphone or tablet via a touch actuator device 100, 500. For this purpose, the touch actuator device 100, 500 could be integrated into the dashboard of the car, for example in a dedicated slot, tray, box or the glove compartment, so that device 200 could be rapidly interconnected via touch actuator device 100, 500 to the automotive electronics.

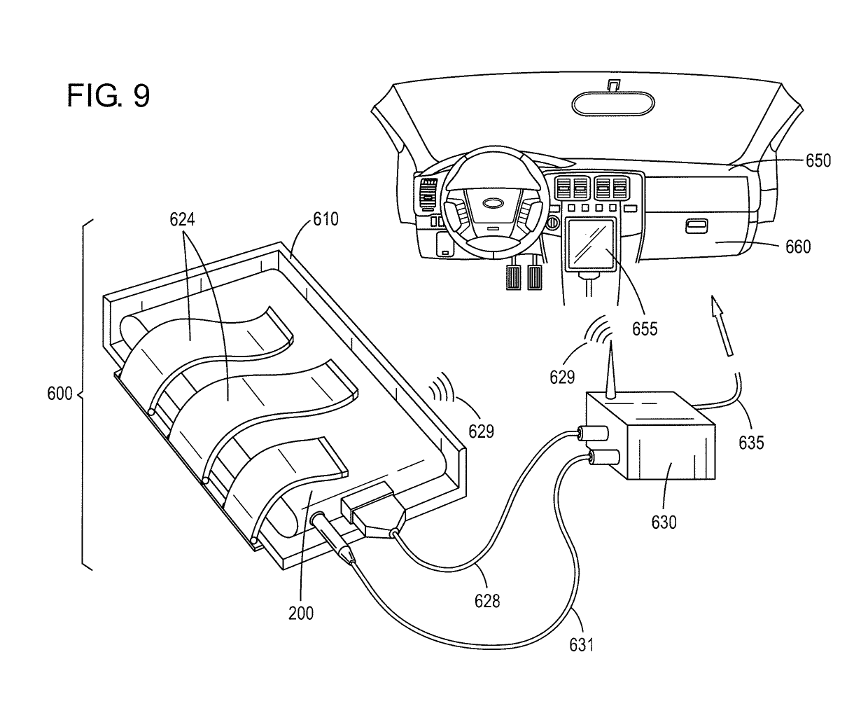

FIG. 9 schematically depicts a system 600 that is configured to connect an electronic device 200 having a touch screen 210 with automotive electronics. Electronic device 200 can be connected to actuator array 610 by placing electronic device 200 into actuator array 610, and by fastening device 200 to actuator array 610 with a multi-point clamping structure 624. Next, device 200 is connected via its connection port or interface via connection 628, for example, through a USB connection, to a control module 630 that is either an integral part of the automotive electronic system or a separate part in communication with the automotive electronic system. This connection can also be established wirelessly, for example via a Bluetooth™, Wi-Fi, or infrared communication 629. Also, it is possible that a separate connection 631 between device 200 and control module 630 or automotive electronic system may be provided, for example, a digital or analog audio and video connection 631. As the electronic device 200 is already connected to actuator array 610, array 610 can operate device 200 to activate the communication, for example by enabling the Bluetooth connectivity. Next, device 200 and control module 630 establish a communication with each other via interface 628 or 629 to display the contents of touch screen 210 of device 200 onto the touch screen 655 of the vehicle 650. In the variant shown, the touch screen 655 of vehicle is placed in a central area of the middle console. Thereby, the familiar graphical user interface of the device 200 is reproduced on touch screen 655 of the vehicle, and the user can operate the device 200 remotely via graphical user interface presented on touch screen 655. The automotive electronic system communicates user touch signals via control module 630 to device 200, and in turn, the device 200 can output additional data other than the graphical user interface of the display, for example but not limited to audio signals, additional video signals, data for controlling other electronic devices of the vehicle, for example via available connections 628, 629, 631. Actuator array 610 can be placed in the glove compartment 660 or a dedicated slot, tray, or box for interconnection with automotive electronic system. Moreover, with system 600, it may be possible to legally operate a smartphone or tablet in a car, as the already installed automotive electronic system is operated via built-in touch screen 655, and does not require the operation of an additional electronic device in the vehicle by a driver, which is illegal in many jurisdictions.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

1. An apparatus for emulating user interaction with a touch screen device comprising:
an actuator array having rows and columns of actuator pads, the actuator pads being arranged to interact with a tactile surface of the touch screen of the touch screen device, each actuator pad being configured to generate a touch event on the tactile surface of the touch screen device;
an actuator array driver including driving units for each actuator pad, each driving unit configured to receive a control signal for generating the touch event by starting and stopping the touch event of the corresponding actuator pad; and
an actuator array controller connected to the actuator array driver, the actuator array controller configured to generate the control signal for the driver.

2: The apparatus according to claim 1, wherein the touch screen is a capacitive touch screen, and
each of the actuator pads include a conductive contact surface that is configured to contact the tactile surface, and
wherein the touch event includes applying an electric signal via the actuator pads to the tactile surface of the touch screen.

3: The apparatus according to claim 1, wherein the actuator array controller is configured to generate control signals for emulating the touch event by using a group of actuator pads to establish a virtual touch point, such that each actuator pad and corresponding driving unit of the group of actuator pads emulates the touch event simultaneously or in rapid succession.

4: The apparatus according to claim 3, wherein the actuator pads included in the group of actuator pads are neighboring actuator pads of the actuator array.

5: The apparatus according to claim 1, wherein the actuator array and the actuator array driver are made of transparent material permitting viewing of content displayed on the touch screen device.

6: The apparatus according to claim 1, wherein the touch screen is a resistive touch screen, and
each of the actuator pads include a pressure element that is configured to exert pressure on the tactile surface of the touch screen, and
the touch event includes an exertion of pressure by the pressure element to a touch location of the tactile surface of the touch screen.

7: The apparatus according to claim 1, wherein each actuator array driver includes an opto-isolator such that the corresponding actuator pad and the actuator array controller are galvanically separated.

8: A method of controlling a touch screen device, comprising the steps of:
attaching the touch screen device to an actuator array that is configured to generate touch events for a touch screen of the touch screen device, the actuator array covering the touch screen such that the actuator array can operate the touch screen;
receiving touch control signals from a remote device over the network at a control device, the control device operatively connected to the actuator array; and
generating touch events for the touch screen by the actuator array, based on the received touch signals.
